(19) United States
(12) Patent Application Publication
(10) Pub. No.: US 2024/0375016 A1
(43) Pub. Date: Nov. 14, 2024

(54) INFORMATION-PROCESSING SYSTEM, INFORMATION-PROCESSING DEVICE, SERVER, PORTALBE INFORMATION-PROCESSING TERMINAL, STORAGE MEDIUM, AND INFORMATION-PROCESSING METHOD

(71) Applicant: NINTENDO CO., LTD., Kyoto-shi (JP)

(72) Inventors: Ikki NIWA, Kyoto-shi (JP); Yusuke AKIFUSA, Kyoto-shi (JP)

(21) Appl. No.: 18/781,844

(22) Filed: Jul. 23, 2024

Related U.S. Application Data
(63) Continuation of application No. PCT/JP2023/000747, filed on Jan. 13, 2023.

(30) Foreign Application Priority Data
Jan. 24, 2022 (JP) 2022-008598

(51) Int. Cl. A63F 13/795; A63F 13/211; A63F 13/213; A63F 13/2145; A63F 13/48; A63F 13/533; H04N 21/414; H04N 21/4223; H04N 21/478

(52) U.S. Cl. CPC A63F 13/795; A63F 13/211; A63F 13/213; A63F 13/2145; A63F 13/48; A63F 13/533; H04N 21/41407; H04N 21/41415; H04N 21/4223; H04N 21/4781

(57) ABSTRACT

An information-processing system includes a game-processing system and portable information-processing terminals. The game-processing system determines a first image that includes connection destination information used for participation in a participatory game, and that is to be displayed on a first display device. The game-processing system also, after one of the portable information-processing terminals connects to the game-processing system, allows a user of the one of the portable information-processing terminals to participate in the participatory game. Each of the portable information-processing terminals determines a second image that includes the connection destination information and is to be displayed on a second display device of the respective portable information-processing terminals. Each of the portable information-processing terminals also, upon detecting that third image captured by the respective portable information-processing terminals includes the first image or the second image, connects to the game-processing system by use of the connection destination information included in the first image or the second image.

### CROSS REFERENCE TO RELATED APPLICATIONS

The disclosure of Japanese Patent Application No. 2022-008598, filed on Jan. 24, 2022, is incorporated herein by reference.

### FIELD

An embodiment of the present invention relates to a method for participating in a participatory game.

### BACKGROUND AND SUMMARY

There is known in the art a method for participating in a community by use of a QR code (registered trademark).

An information-processing system according to an embodiment of the present invention includes a game-processing system and portable information-processing terminals. The game-processing system comprises a first processor and a first memory coupled thereto. The first processor is configured to control the game-processing system to at least: execute a participatory game in which plural users can participate; determine a first image that includes connection destination information used for participation in the participatory game, and that is to be displayed on a first display device; and after one of the portable information-processing terminals connects to the game-processing system, allow a user of the one of the portable information-processing terminals to participate in the participatory game. The one of the portable information-processing terminals, comprises a second processor, a second memory coupled thereto, a second display device, and a camera device. The second processor is configured to control the one of the portable information-processing terminals to at least: determine a second image that includes the connection destination information and is to be displayed on the second display device; control the camera device to capture a third image; and upon detecting that the captured third image includes the first image or the second image, connect to the game-processing system by use of the connection destination information included in the first image or the second image.

### BRIEF DESCRIPTION OF THE DRAWINGS

FIG. 1 is a diagram showing an example of an information-processing system.

FIG. 2 is a diagram showing an example of a situation in which a bingo game is being played.

FIG. 3 is a block diagram showing an example of game device 1.

FIG. 4 is a diagram showing an example of a memory map of volatile memory 13.

FIG. 5 is a block diagram showing an example of server 3.

FIG. 6 is a diagram showing an example of a memory map of volatile memory 33.

FIG. 7 is a block diagram showing an example of a smartphone 4.

FIG. 8 is a diagram showing an example of a memory map of volatile memory 43.

FIG. 9 is a sequence diagram showing an example of participation registration processing.

FIG. 10 is a diagram showing an example of a two-dimensional code displayed on TV monitor 2.

FIG. 11 is a diagram showing an example of a two-dimensional code displayed on display 45.

FIG. 12 is a flowchart showing an example of bingo game execution processing.

FIG. 13 is a diagram showing an example of a bingo card displayed on display 45.

FIG. 14 is a diagram showing an example of a roulette screen displayed on TV monitor 2.

FIG. 15 is a diagram showing an example of a pause screen.

FIG. 16 is a diagram showing an example of an option screen.

### DETAILED DESCRIPTION OF NON-LIMITING EXAMPLE EMBODIMENTS

### 1. Embodiment

### 1-1. Configuration

An information-processing system according to an embodiment of the present invention will be described with reference to the drawings.

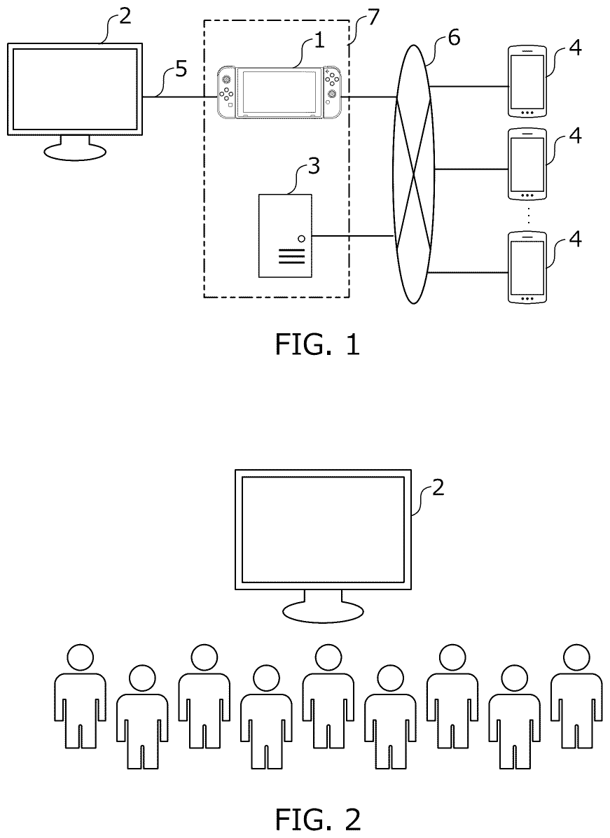

FIG. 1 is a diagram showing an example of the information-processing system. As shown in the figure, the information-processing system includes game device 1, TV monitor 2, server 3, and smartphones 4. Of the devices constituting the information-processing system, game device 1 and TV monitor 2 are connected by dedicated line 5, and game device 1, server 3 and smartphones 4 are connected via communication line 6 such as the Internet. Game device 1 and server 3 constitute game-processing system 7.

The information-processing system is a system for allowing users of smartphones 4 to play a participatory game, which is specifically a bingo game. FIG. 2 is a diagram showing an example of a situation in which a bingo game is being played. More specifically, the figure shows a closed space such as a party venue, in which many users of smartphone 4 are playing a bingo game by use of TV monitor 2.

To participate in a bingo game, a user of a smartphone 4 needs to register for participation in the bingo game by scanning a two-dimensional code displayed on TV monitor 2 or on another user's smartphone 4. When the user has completed the registration for participation, a bingo card is provided to his/her smartphone 4 to be displayed thereon. Subsequently, a number is drawn using a roulette wheel displayed on TV monitor 2. The drawn number is displayed on smartphones 4 such that the drawn number can be selected on the smartphones 4. Drawing of a number is repeatedly performed. When all numbers of any of a vertical, horizontal, or diagonal line on a bingo card are selected, a bingo pattern is completed. This bingo game is a team game in which a team wins the game if a majority of the team members complete a bingo pattern earlier than the other teams.

Hereinafter, the devices constituting the information-processing system will be described.

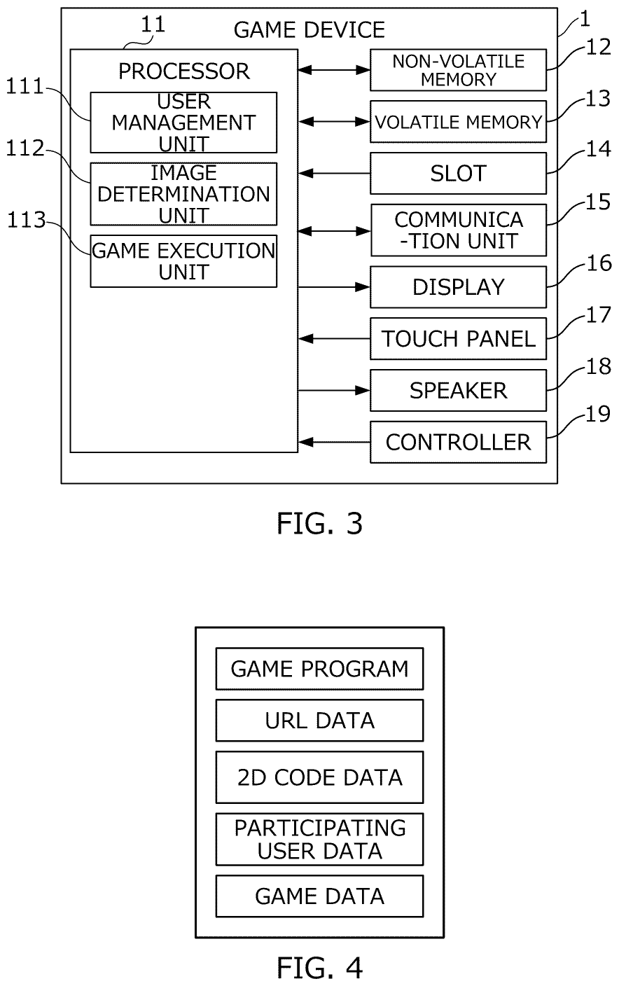

FIG. 3 is a block diagram showing an example of game device 1. As shown in the figure, game device 1 includes processor 11 such as a CPU, non-volatile memory 12 such as a flash memory, volatile memory 13 such as a DRAM, slot 14 into which an external storage medium such as a memory card can be inserted, communication unit 15 for enabling communication with server 3 via communication line 6, display 16 such as a liquid crystal display, touch panel 17 placed on display 16, speaker 18, and controller 19 that includes operation buttons and an analog stick.

FIG. 4 is a diagram showing an example of a memory map of volatile memory 13 included in game device 1. As shown in the figure, volatile memory 13 can store a game program that is retrieved from non-volatile memory 12 or an external storage medium. The game program is an information-processing program for allowing users of smartphones 4 to play a bingo game. This game program is a program that can be distributed via a network such as the Internet or a non-transitory storage medium. Volatile memory 13 also can store URL data, two-dimensional code data, participating user data, and game data. Hereinafter, those items of data to be stored in volatile memory 13 will be described.

URL data is text data indicative of a URL that is used for participation in a bingo game. The URL indicated by this URL data is, specifically, information including an address of server 3 and a room ID, which are connection destination information, and a password, which is authentication information. The URL data is generated on server 3 and is provided to game device 1.

Two-dimensional code data is image data representing a two-dimensional code. This two-dimensional code data is generated based on the URL data stored in volatile memory 13, in accordance with a predetermined algorithm. The two-dimensional code represented by the two-dimensional code data includes information represented by the original URL data.

Participating user data is data on users who are participating in a bingo game. Specifically, this participating user data consists of sets of a user ID, a user name, and face photo data for each user. In the present embodiment, a session ID is used as an example of a user ID.

Game data indicates parameters that are generated during execution of a bingo game. Specifically, this game data consists of team data indicating members of each of teams, bingo card data indicating bingo cards that have been provided to each user, selected-number data indicating numbers that have been selected on a bingo card by each user, and bingo user data indicating users who have completed a bingo pattern. These parameters are used to execute a bingo game.

The above-mentioned game program is loaded into volatile memory 13 and is executed by processor 11. As a result, functions of user management unit 111, image determination unit 112, and game execution unit 113 are provided, as shown in FIG. 3.

User management unit 111 is configured to request server 3 to create a room, and to manage participating user data for users who have entered the created room.

Image determination unit 112 is configured to generate two-dimensional code data based on URL data stored in volatile memory 13, in accordance with a predetermined algorithm. Image determination unit 112 is also configured to cause TV monitor 2 to display a two-dimensional code based on the generated two-dimensional code data. It is of note that a screen of TV monitor 2 on which the two-dimensional code is displayed is larger than a screen displayed on display 45 of a smartphone 4.

Game execution unit 113 is configured to execute a bingo game based on input data sent from each of smartphones 4. The input data sent from each of smartphones 4 is input using touch panel 46 and motion sensor 49 on the respective smartphones 4. The foregoing is a description of game device 1.

Now, server 3 will be described.

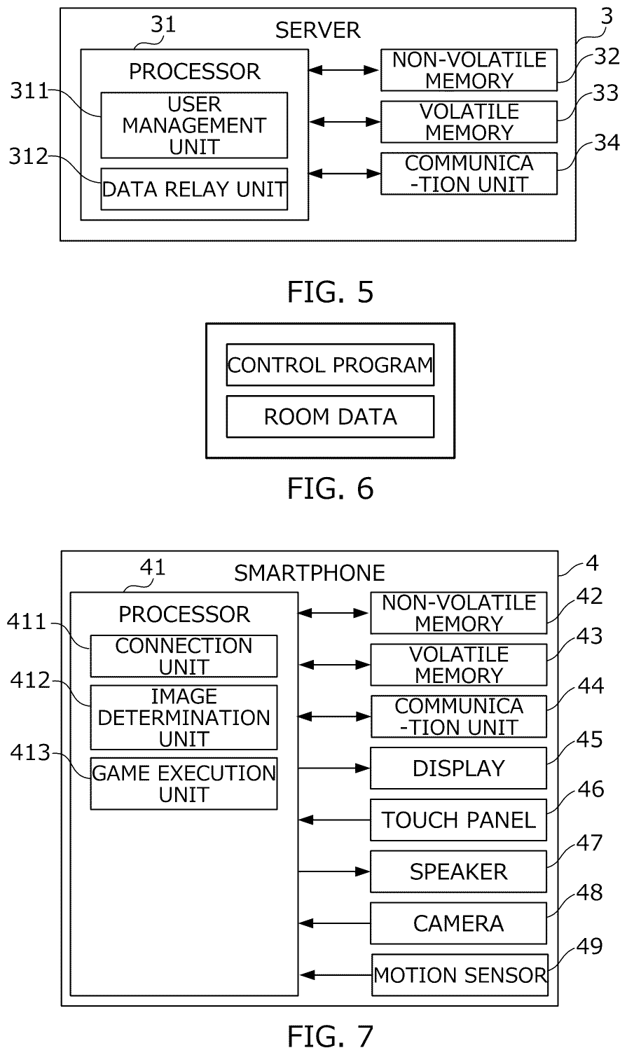

FIG. 5 is a block diagram showing an example of server 3. As shown in the figure, server 3 includes processor 31 such as a CPU, non-volatile memory 32 such as an HDD, volatile memory 33 such as a DRAM, and communication unit 34 for enabling communication with game device 1 or a smartphone 4 via communication line 6.

FIG. 6 is a diagram showing an example of a memory map of volatile memory 33 included in server 3. As shown in the figure, volatile memory 33 can store a control program that is retrieved from non-volatile memory 32. The control program is an information-processing program for allowing users of smartphones 4 to play a bingo game. Volatile memory 33 can also store room data, which is data on virtual rooms that have been created on server 3. The room data, specifically, consists of sets of a room ID, a password, and user IDs of users who have entered a room, for each room. A bingo game is played in each room identified by the room data.

The above-mentioned control program is loaded into volatile memory 33 and is executed by processor 31. As a result, functions of user management unit 311 and data relay unit 312 are provided, as shown in FIG. 5.

User management unit 311 is configured to accept a room creation request sent from game device 1, and to create a room in response to the request. When creating a room, user management unit 311 issues a room ID and a password, and stores them in volatile memory 33 in association with a user ID of game device 1.

User management unit 311 is also configured to generate URL data, which is text data indicative of a URL that is used for participation in a bingo game. The URL indicated by the URL data is, specifically, information including an address of server 3 and an issued pair of a room ID and a password. User management unit 311 is also configured to send generated URL data to game device 1.

User management unit 311 is further configured to acquire a participation registration request sent from a smartphone 4, and to determine whether a pair of a room ID and a password included in the acquired participation registration request is stored in volatile memory 33. User management unit 311 performs the determination to prevent an unspecified user from entering a room. When user management unit 311 determines that a pair of a room ID and a password included in a participation registration request is stored in volatile memory 33, the unit stores a user ID of the source smartphone 4 in volatile memory 33 in association with the room ID. This association of the user ID and the room ID enables a user of the smartphone 4 to participate in a bingo game that is to be played in a room identified by the room ID.

Data relay unit 312 is configured to relay data between game device 1 and a smartphone 4, which is associated with a same room ID as game device 1.

The foregoing is a description of server 3.

Now, a smartphone 4 will be described.

FIG. 7 is a block diagram showing an example of a smartphone 4. As shown in the figure, the smartphone 4 includes processor 41 such as a CPU, non-volatile memory 42 such as a flash memory, volatile memory 43 such as a DRAM, communication unit 44 for enabling communication with server 3 via communication line 6, display 45 such as a liquid crystal display, touch panel 46 placed on display 45, speaker 47, camera 48, and motion sensor 49.

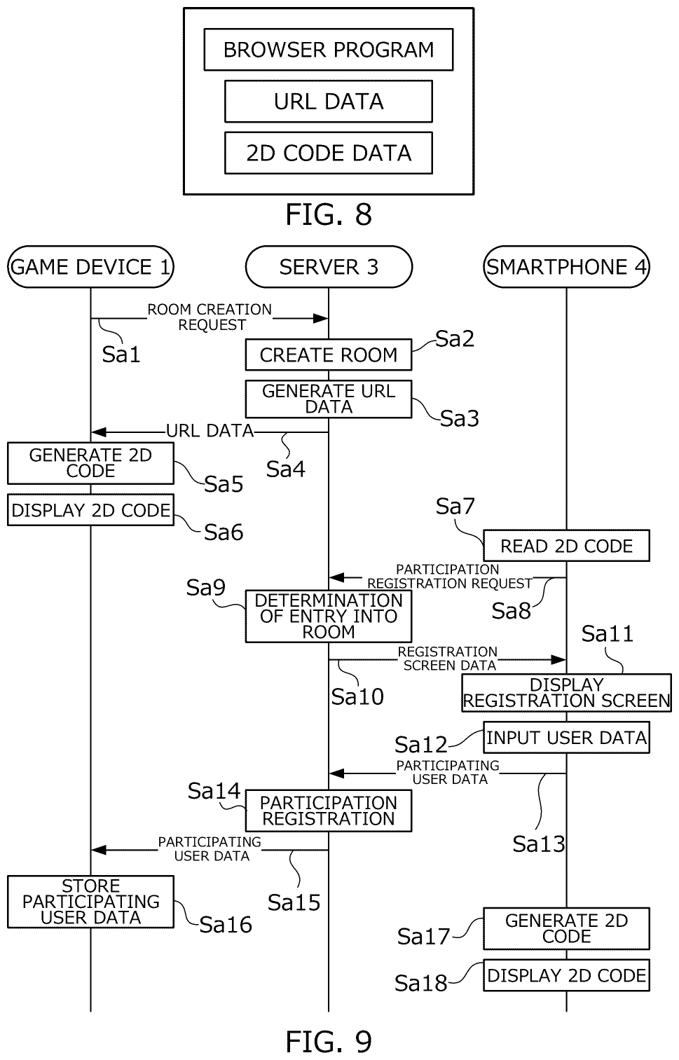

FIG. 8 is a diagram showing an example of a memory map of volatile memory 43 included in the smartphone 4. As shown in the figure, volatile memory 43 can store a browser program that is retrieved from non-volatile memory 42. The browser program is an information-processing program for allowing a user of the smartphone 4 to play a bingo game. This browser program is a program that can be distributed via a network such as the Internet or a non-transitory storage medium. Volatile memory 43 can also store URL data and two-dimensional code data.

URL data is text data indicative of a URL that is used for participation in a bingo game. The URL indicated by this URL data is, specifically, information including an address of server 3 and a room ID, which are connection destination information, and a password, which is authentication information. The URL data is generated by causing camera 48 to read a two-dimensional code that is displayed on TV monitor 2 or another smartphone 4.

Two-dimensional code data is image data representing a two-dimensional code. This two-dimensional code data is generated based on the URL data stored in volatile memory 43, in accordance with a predetermined algorithm. The two-dimensional code represented by the two-dimensional code data includes information represented by the original URL data.

The above-mentioned browser program is loaded into volatile memory 43 and is executed by processor 41. As a result, functions of connection unit 411, image determination unit 412, and game execution unit 413 are provided, as shown in FIG. 7.

Connection unit 411 is configured to connect to server 3 by use of URL data stored in volatile memory 43. More specifically, connection unit 411 is configured to send to server 3, a participation registration request including a set of a room ID and a password included in the URL data.

Image determination unit 412 is configured to generate two-dimensional code data based on URL data stored in volatile memory 43, in accordance with a predetermined algorithm. Image determination unit 412 is also configured to cause display 45 to display a two-dimensional code based on generated two-dimensional code data.

Game execution unit 413 is configured to acquire a bingo card data that is sent from game device 1, and to cause display 45 to display the acquired bingo card. Game execution unit 413 is also configured to acquire drawn-number data that is sent from game device 1, and to determine whether a drawn number indicated by the acquired drawn-number data has been selected by a user on the bingo card. Game execution unit 413 is further configured, in a case where the drawn number has been selected by a user, to send to game device 1, input data indicating that the drawn number has been selected.

### 1-2. Operation

An operation of the information-processing system will be described. Specifically, participation registration processing that is performed before a bingo game is started, and bingo game execution processing will be described.

### 1-2-1. Participation Registration Processing

FIG. 9 is a sequence diagram showing an example of participation registration processing. It is of note that the sequence diagram shows only one of smartphones 4 to facilitate clear explanation.

In the participation registration processing, a user of game device 1 initially creates a room on server 3 to play a bingo game. To create a room, the user performs a predetermined operation on game device 1. In response to the operation, user management unit 111 of game device 1 sends a room creation request to server 3 (step Sa1). In response to the room creation request, user management unit 311 of server 3 creates a room (step Sa2). Specifically, user management unit 311 issues a room ID and a password, and stores them in volatile memory 33 in association with a user ID of game device 1. Subsequently, user management unit 311 generates URL data (step Sa3), which is text data indicative of a URL that is used for participation in a bingo game. The URL represented by the URL data is, specifically, information including an address of server 3 and the pair of the room ID and the password issued at step Sa2. User management unit 311 sends the generated URL data to game device 1 (step Sa4).

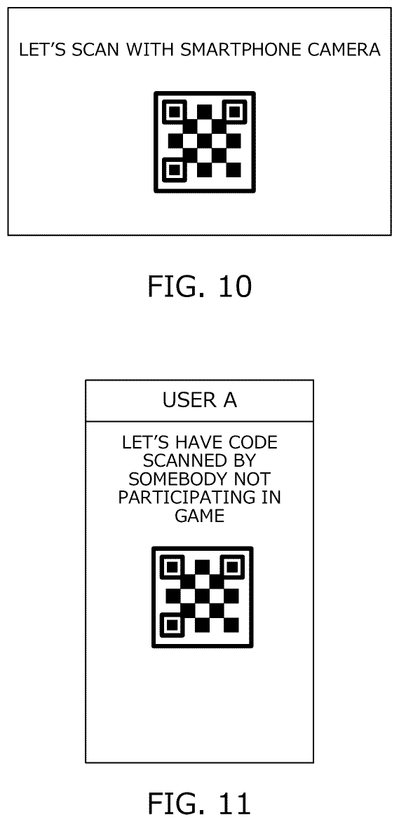

When image determination unit 112 of game device 1 acquires the URL data, the unit generates two-dimensional code data based on the acquired URL data, in accordance with a predetermined algorithm (step Sa5). Subsequently, image determination unit 112 causes TV monitor 2 to display a two-dimensional code based on the generated two-dimensional code data (step Sa6). FIG. 10 is a diagram showing an example of the two-dimensional code displayed on TV monitor 2. The two-dimensional code displayed as shown in the figure can be read by smartphones 4. Since the two-dimensional code is displayed on TV monitor 2, which is so large that many users can view it simultaneously, the two-dimensional code can be read by many smartphones 4 simultaneously.

When the two-dimensional code is read by camera 48 of a smartphone 4 (step Sa7), the smartphone 4 generates URL data, which is the same data as the URL data generated at step Sa3. Connection unit 411 of the smartphone 4 connects to server 3 by use of the URL data (step Sa8). Specifically, connection unit 411 sends to server 3, a participation registration request including the pair of the room ID and the password issued at step Sa2. When user management unit 311 of server 3 acquires the participation registration request, the unit determines whether the pair of the room ID and the password included in the acquired participation registration request is stored in volatile memory 33 (step Sa9). As a result of the determination, when the pair of the room ID and the password is stored in volatile memory 33, user management unit 311 sends registration screen data to the smartphone 4 (step Sa10). On the other hand, when the pair of the room ID and the password pair is not stored in volatile memory 33, user management unit 311 sends an error message to the smartphone 4.

When connection unit 411 of the smartphone 4 acquires the registration screen data, the unit causes display 45 to display a registration screen (step Sa11), which is a screen for a user of the smartphone 4 to register a user name and face photo data in game device 1. When the user completes input of a user name and face photo data on the registration screen (step Sa12), connection unit 411 sends the input items of data and a user ID to server 3 as participating user data (step Sa13).

When user management unit 311 of server 3 acquires the participating user data, the unit stores the user ID of the smartphone 4 in volatile memory 33 in association with the room ID acquired at step Sa9 (step Sa14). This association of the user ID and the room ID enables the user of the smartphone 4 to participate in a bingo game that is to be played in a room identified by the room ID. User management unit 311 also sends the acquired participating user data to game device 1 (step Sa15). When user management unit 111 of game device 1 acquires the participating user data, the unit stores the data in volatile memory 13 (step Sa16).

After the participating user data is sent to server 3, image determination unit 412 of the smartphone 4 generates two-dimensional code data based on the URL data generated at step Sa7, in accordance with a predetermined algorithm (step Sa17). Subsequently, image determination unit 412 causes display 45 to display a two-dimensional code based on the generated two-dimensional code data (step Sa18). FIG. 11 is a diagram showing an example of the two-dimensional code displayed on display 45. The two-dimensional code displayed as shown in the figure can be read by another smartphone 4. When the two-dimensional code is read by another smartphone 4, steps Sa7 to Sa18 are carried out to register for participation of a user of the other smartphone 4.

The foregoing is a description of participation registration processing.

In the participation registration processing described in the foregoing, a two-dimensional code is required for registration for participation in a bingo game, and is displayed on TV monitor 2. Since TV monitor 2 is so large that many users can view it simultaneously, the two-dimensional code can be read by many smartphones 4 simultaneously for registration for participation. In addition, a similar two-dimensional code is displayed on a smartphone 4 of a user who has registered for participation. A user of a smartphone 4 who has not yet registered for participation can perform the registration by scanning the two-dimensional code. In summary, the above participation registration processing can achieve efficient registration for participation of many users in a bingo game.

### 1-2-2. Bingo Game Execution Processing

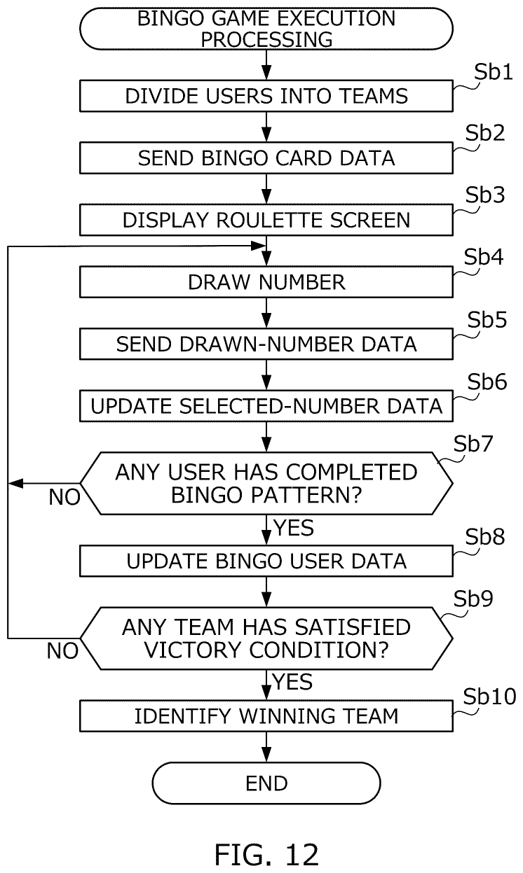

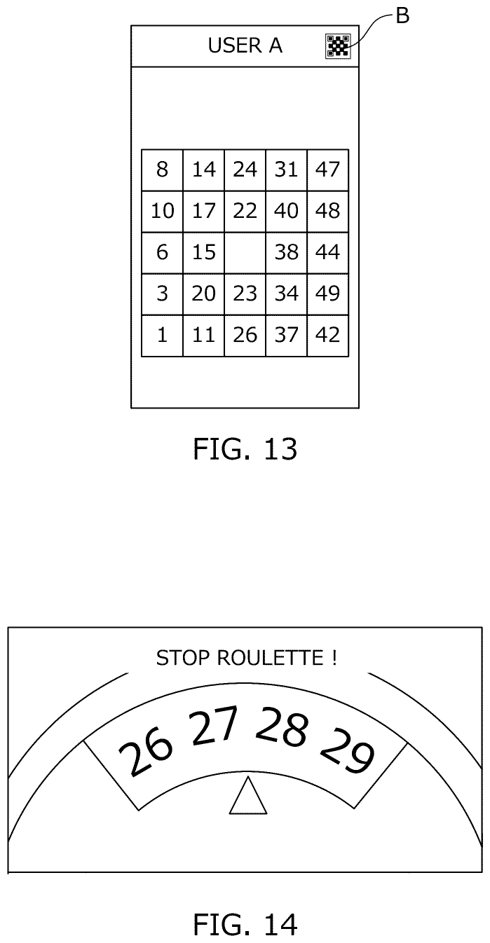

FIG. 12 is a flow diagram showing an example of bingo game execution processing. In the bingo game execution processing shown in the figure, game execution unit 113 of game device 1 initially divides participating users into two teams to start a bingo game (step Sb1). This division of participating users may be performed manually by a user of game device 1, or may be automatically performed. After dividing participating users into two teams, game execution unit 113 sends different bingo card data to each of smartphones 4 (step Sb2). When game execution unit 413 of a smartphone 4 acquires bingo card data, the unit causes display 45 to display a bingo card. FIG. 13 is a diagram showing an example of the bingo card displayed on display 45.

Game execution unit 113 of game device 1, after sending the bingo card data, causes TV monitor 2 to display a roulette screen (step Sb3). FIG. 14 is a diagram showing an example of the roulette screen displayed on TV monitor 2. After displaying the roulette screen, game execution unit 113 accepts an input operation performed by a user of game device 1 on the roulette screen, and in response to the input operation, draws a number (step Sb4). Subsequently, game execution unit 113 sends drawn-number data indicating the drawn number to each of smartphones 4 (step Sb5). When game execution unit 413 of a smartphone 4 acquires the drawn-number data, the unit determines whether the drawn number has been selected by a user on a bingo card. As a result of the determination, when the drawn number has been selected by the user, game execution unit 413 sends, to game device 1, input data indicating that the drawn number has been selected. When game execution unit 113 of game device 1 acquires input data from each of the smartphones 4, the unit updates selected-number data stored in volatile memory 13 based on the acquired input data (step Sb6).

After updating selected-number data, game execution unit 113 determines whether a user has completed a bingo pattern, based on the updated selected-number data (step Sb7). As a result of the determination, when a user has completed a bingo pattern (YES at step Sb7), game execution unit 113 updates bingo user data stored in volatile memory 13 (step Sb8), and proceeds to step Sa9. On the other hand, as a result of the determination, when no user has completed a bingo pattern (NO at step Sb7), game execution unit 113 returns back to step Sb4, without updating bingo user data.

At step Sb9, game execution unit 113 determines whether any one of the teams has satisfied a victory condition, based on the updated bingo user data. The victory condition to be satisfied here refers to a condition that a majority of team members complete a bingo pattern. As a result of the determination, when any one of the teams has satisfied the victory condition (YES at step Sb9), game execution unit 113 determines that the team that has satisfied the victory condition is a winning team (step Sb10), and ends the bingo game. On the other hand, as a result of the determination, when no team has satisfied the victory condition (NO at step Sb9), game execution unit 113 returns to step Sb4.

The foregoing is a description of bingo game execution processing.

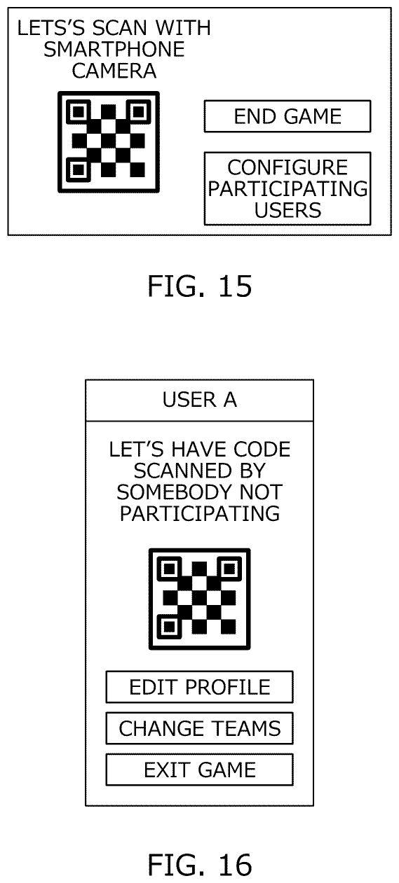

It is of note that during the bingo game execution processing, a user of game device 1 can cause TV monitor 2 to display a pause screen. When the user selects a pause button, game execution unit 113 of game device 1 interrupts progress of the bingo game and causes TV monitor 2 to display a pause screen. FIG. 15 is a diagram showing an example of the pause screen. As shown in the figure, the pause screen shows the two-dimensional code that is displayed on TV monitor 2 at step Sa6. A user of a smartphone 4 who has not yet registered for participation can perform the registration by scanning the two-dimensional code. A user who has registered for participation can participate in a subsequent bingo game.

It is also of note that during the bingo game execution processing, a user of a smartphone 4 can cause display 45 to display an option screen. When the user selects an option button (see reference numeral B shown in FIG. 13), game execution unit 413 of the smartphone 4 causes display 45 to display an option screen. FIG. 16 is a diagram showing an example of the option screen. As shown in the figure, the option screen shows the two-dimensional code that is displayed on display 45 at step Sa18. A user of a smartphone 4 who has not yet registered for participation can perform the registration by scanning the two-dimensional code. A user who has registered for participation can participate in a subsequent bingo game. It is of note that display of the option screen does not interrupt progress of the bingo game, in contrast to display of the pause screen.

### 2. Modifications

The above embodiment may be modified as described below. The modifications described below may be combined with each other.

### 2-1. Modification 1

Game device 1 is an example of an information-processing device capable of executing the above game program. Instead of game device 1, another information-processing device such as a smartphone may be used to execute the above game program.

### 2-2. Modification 2

A smartphone 4 is an example of a portable information-processing terminal capable of executing the above browser program. Instead of a smartphone 4, another portable information-processing terminal such as a tablet terminal may be used to execute the above browser program.

### 2-3. Modification 3

Part or all of the functions of game device 1 may be provided by server 3. On the contrary, part or all of the functions of server 3 may be provided by game device 1. In essence, arrangement of functions of the game processing system may be freely determined by a provider of the system.

### 2-4. Modification 4

A bingo game is an example of a participatory game that can be provided by the above information-processing system. The above information-processing system may provide a competitive game or a cooperative game, instead of a bingo game. Alternatively, the above information-processing system may provide a questionnaire survey service as an example of a game.

### 2-5. Modification 5

Game device 1 may cause display 16 of the game device to display a two-dimensional code, in addition to or instead of TV monitor 2. Alternatively, game device 1 may cause a projector to show a two-dimensional code on a screen.

### 2-6. Modification 6

Game device 1 and a smartphone 4 may generate a barcode or an image in which a digital watermark is embedded, instead of a two-dimensional code, and cause it to be displayed on a display device. Alternatively, game device 1 and a smartphone 4 may generate an image representing text of URL data, and cause it to be displayed on a display device. In this case, an image displayed on the display device is subjected to character recognition whereby the original URL data can be extracted.

It is of note that game device 1 and a smartphone 4 may generate a different type of image and cause it to be displayed on a display device. For example, game device 1 may generate and display a two-dimensional code, while a smartphone 4 may generate and display a barcode.

### 2-7. Modification 7

Game device 1 may acquire, instead of URL data, two-dimensional code data generated based on the URL data from server 3. In that case, image determination unit 112 of game device 1, instead of generating two-dimensional code data from URL data, acquires two-dimensional code data from server 3, and causes TV monitor 2 to display a two-dimensional code based on the acquired two-dimensional code data.

### 2-8. Modification 8

A smartphone 4 may acquire a two-dimensional code from server 3, instead of generating a two-dimensional code on its own device. For example, in the above participation registration processing, server 3 may receive participating user data from a smartphone 4, and in response to the participating user data, send two-dimensional code data to the smartphone 4. In that case, image determination unit 412 of the smartphone 4 causes display 45 to display a two-dimensional code based on the two-dimensional code data acquired from server 3, without generating two-dimensional code data from URL data.

### 2-9. Modification 9

A smartphone 4 may generate a two-dimensional code based on URL data and a user ID of the smartphone 4. The two-dimensional code generated in such a manner includes the URL data and the user ID of the smartphone 4. When the two-dimensional code is read by another smartphone 4, the other smartphone 4 extracts the URL data and the user ID from the two-dimensional code. Of the extracted items of data, the user ID indicates from which smartphone 4 the other smartphone 4 has read the two-dimensional code for registration for participation. Game device 1 may acquire the user ID and form teams based on the acquired user ID such that the other smartphone 4 that has read the two-dimensional code and the smartphone 4 from which the two-dimensional code has been read belong to a same team. In other words, game device 1 may associate a user ID of the other smartphone 4 that has read the two-dimensional code and the user ID of the smartphone 4 from which the two-dimensional code has been read, when generating team data.

### 2-10. Modification 10

In the above bingo game execution processing, a bingo game is played as a team game; however, a bingo game may be played in an individual game.

### 2-11. Modification 11

In the above participation registration processing, a password is used as authentication information in order to prevent an unspecified user from entering a room; however, use of a password may be omitted.

### 2-12. Modification 12

In the above bingo game execution processing, every time a user of a smartphone 4 selects a drawn number, the smartphone 4 sends, to game device 1, input data indicating that the drawn number has been selected. However, this timing of transmission of input data is merely an example. Input data may be sent only in the following three cases.
(1) When a minimum number of cells (in the case of the bingo card shown in FIG. 13, four cells) required for completion of a bingo pattern are punched.
(2) When the number of lines of numbers that need one number to complete a bingo pattern increases, which includes a case where the number of such lines increases from zero to one.
(3) When a bingo pattern is completed.

### 2-13. Modification 13

In the above bingo game execution processing, game execution unit 113 of game device 1 draws a number in response to an input operation performed by a user of game device 1; however, game execution unit 113 may draw a number in response to an input operation performed by a user of a smartphone 4, instead of a user of game device 1.

What is claimed is:

1. An information-processing system that includes a game-processing system and portable information-processing terminals, the game-processing system comprising a first processor and a first memory coupled thereto, the first processor being configured to control the game-processing system to at least:
execute a participatory game in which plural users can participate;
determine a first image that includes connection destination information used for participation in the participatory game, and that is to be displayed on a first display device; and
after one of the portable information-processing terminals connects to the game-processing system, allow a user of the one of the portable information-processing terminals to participate in the participatory game,
the one of the portable information-processing terminals, comprising a second processor, a second memory coupled thereto, a second display device, and a camera device, the second processor being configured to control the one of the portable information-processing terminals to at least:
determine a second image that includes the connection destination information and is to be displayed on the second display device;
control the camera device to capture a third image; and
upon detecting that the captured third image includes the first image or the second image, connect to the game-processing system by use of the connection destination information included in the first image or the second image;
wherein the second processor is further configured to control the one of the portable information-processing terminals that is used by the user to operate the participatory game being executed, to display the second image on the second display device while the participatory game is being executed in the game-processing system.

2. The information-processing system according to claim 1, wherein the first processor is further configured to control the game-processing system to display the first image on the first display device before the participatory game starts.

3. The information-processing system according to claim 1, wherein the first processor is further configured to control the game-processing system to:
display the first image on the first display device; and
when displaying the first image after the participatory game starts, interrupt the participatory game.

4. The information-processing system according to claim 1, wherein the first processor is configured, while the user is participating in the participatory game, to control the game-processing system to execute the participatory game based on input information that is sent from the one of the portable information-processing terminals.

5. The information-processing system according to claim 4, wherein the one of the portable information-processing terminals further comprises a touch input device or a motion sensor that is configured to output the input information.

6. The information-processing system according to claim 1, wherein the second processor is further configured to control the one of the portable information-processing terminals to:
acquire information sent from the game-processing system; and
determine a game screen or an input screen to be displayed on the second display device, based on the acquired information.

7. The information-processing system according to claim 1, wherein the first processor is further configured to control the game-processing system to send the first image to the one of the portable information-processing terminals in response to a request sent from the one of the portable information-processing terminals.

8. The information-processing system according to claim 1, wherein:
the first image and the second image include authentication information; and
the first processor is configured to control the game-processing system to allow the user to participate in the participatory game only after receiving data including the authentication information from the one of the portable information-processing terminals that has connected to the game-processing system.

9. The information-processing system according to claim 1, wherein:
the second processor is further configured to control the one of the portable information-processing terminals to include, in the second image, information indicating another user of another of the portable information-processing terminals; and
the first processor is configured to control the game-processing system to associate the user of the one of the portable information-processing terminals that has connected to the game-processing system, and the other user.

10. The information-processing system according to claim 1, wherein a display screen of the first display device is larger than a display screen of the second display device.

11. The information-processing system according to claim 1, wherein:
the game-processing system comprises a game device and a server; and
the second processor is configured to control the one of the portable information-processing terminals to connect to the server based on the connection destination information.

12. The information-processing system according to claim 4, wherein:
the game-processing system comprises a game device and a server; and
the input information is sent to the game device through the server.

13. An information-processing device that constitutes an information-processing system together with portable information-processing terminals, the information-processing device comprising a first processor and a first memory coupled thereto, the first processor being configured to control the information-processing device to at least:
execute a participatory game in which plural users can participate;
determine a first image that includes connection destination information used for participation in the participatory game, and that is to be displayed on a first display device; and
after one of the portable information-processing terminals connects to the information-processing device, allow a user of the one of the portable information-processing terminals to participate in the participatory game,
the one of the portable information-processing terminals, comprising a second processor, a second memory coupled thereto, a second display device, and a camera device, the second processor being configured to control the one of the portable information-processing terminals to at least:
determine a second image that includes the connection destination information and is to be displayed on the second display device;
control the camera device to capture a third image; and
upon detecting that the captured third image includes the first image or the second image, connect to the information-processing device by use of the connection destination information included in the first image or the second image;
wherein the second processor is further configured to control the one of the portable information-processing terminals that is used by the user to operate the participatory game being executed, to display the second image on the second display device while the participatory game is being executed in the information-processing device.

14. A server that constitutes an information-processing system together with portable information-processing terminals, the server comprising a first processor and a first memory coupled thereto, the first processor being configured to control the server to at least:
execute a participatory game in which plural users can participate;
determine a first image that includes connection destination information used for participation in the participatory game, and that is to be displayed on a first display device; and
after one of the portable information-processing terminals connects to the server, allow a user of the one of the portable information-processing terminals to participate in the participatory game,
the one of the portable information-processing terminals, comprising a second processor, a second memory coupled thereto, a second display device, and a camera device, the second processor being configured to control the one of the portable information-processing terminals to at least:
determine a second image that includes the connection destination information and is to be displayed on the second display device;
control the camera device to capture a third image; and
upon detecting that the captured third image includes the first image or the second image, connect to the server by use of the connection destination information included in the first image or the second image;
wherein the second processor is further configured to control the one of the portable information-processing terminals that is used by the user to operate the participatory game being executed, to display the second image on the second display device while the participatory game is being executed in the server.

15. A portable information-processing terminal that constitutes an information-processing system together with a game-processing system, the game-processing system comprising a first processor and a first memory coupled thereto, the first processor being configured to control the game-processing system to at least:
execute a participatory game in which plural users can participate;
determine a first image that includes connection destination information used for participation in the participatory game, and that is to be displayed on a first display device; and
after the portable information-processing terminal connects to the game-processing system, allow a user of the portable information-processing terminal to participate in the participatory game,
the portable information-processing terminal comprising a second processor, a second memory coupled thereto, a second display device, and a camera device, the second processor being configured to control the portable information-processing terminal to at least:
determine a second image that includes the connection destination information and is to be displayed on the second display device;
control the camera device to capture a third image; and
upon detecting that the captured third image includes the first image or the second image, connect to the game-processing system by use of the connection destination information included in the first image or the second image;
wherein the second processor is further configured to control the portable information-processing terminal that is used by the user to operate the participatory game being executed, to display the second image on the second display device while the participatory game is being executed in the game-processing system.

16. A non-transitory computer-readable storage medium having stored therein instructions that, when executed by a first processor of an information-processing device that constitutes an information-processing system together with portable information-processing terminals, cause the information-processing device to perform operations comprising:
executing a participatory game in which plural users can participate;
determining a first image that includes connection destination information used for participation in the participatory game, and that is to be displayed on a first display device; and
after one of the portable information-processing terminals connects to the information-processing device, allowing a user of the one of the portable information-processing terminals to participate in the participatory game,
the one of the portable information-processing terminals, comprising a second processor, a memory coupled thereto, a second display device, and a camera device, the second processor being configured to control the one of the portable information-processing terminals to at least:
determine a second image that includes the connection destination information and is to be displayed on the second display device;
control the camera device to capture a third image; and
upon detecting that the captured third image includes the first image or the second image, connect to the information-processing device by use of the connection destination information included in the first image or the second image;
wherein the second processor is further configured to control the one of the portable information-processing terminals that is used by the user to operate the participatory game being executed, to display the second image on the second display device while the participatory game is being executed in the information-processing device.

17. An information-processing method executed by an information-processing device that constitutes an information-processing system together with portable information-processing terminals, the method comprising:
executing a participatory game in which plural users can participate;
determining a first image that includes connection destination information used for participation in the participatory game, and that is to be displayed on a first display device; and
after one of the portable information-processing terminals connects to the information-processing device, allowing a user of the one of the portable information-processing terminals to participate in the participatory game,
the one of the portable information-processing terminals, comprising a processor, a memory coupled thereto, a second display device, and a camera device, the processor being configured to control the one of the portable information-processing terminals to at least:
determine a second image that includes the connection destination information and is to be displayed on the second display device;
control the camera device to capture a third image; and
upon detecting that the captured third image includes the first image or the second image, connect to the information-processing device by use of the connection destination information included in the first image or the second image;
wherein the processor is further configured to control the one of the portable information-processing terminals that is used by the user to operate the participatory game being executed, to display the second image on the second display device while the participatory game is being executed in the information-processing device.
